(19) United States
(12) Patent Application Publication
(10) Pub. No.: US 2022/0168934 A1
(43) Pub. Date: Jun. 2, 2022

(54) PROCESSING METHOD FOR COATING GLASS CONTAINER WITH SILICONE RUBBER AND GLASS CONTAINER COATED WITH SILICONE RUBBER

(71) Applicant: TINYSGOOD DESIGN PTY LTD, Victoria (AU)

(72) Inventor: Min SHEN, Guangdong (CN)

(73) Assignee: TINYSGOOD DESIGN PTY LTD, Victoria (AU)

(21) Appl. No.: 17/203,694

(22) Filed: Mar. 16, 2021

(30) Foreign Application Priority Data
Dec. 2, 2020 (CN) 202011391548.5

(51) Int. Cl. B29C 45/14; A47G 19/22; B65D 1/02

(52) U.S. Cl. CPC B29C 45/14434; A47G 19/2205; B29K 2709/08; B29C 45/14311; B29C 2045/14868; B65D 1/0215

(57) ABSTRACT

The present invention relates to a processing method for coating glass container with silicone rubber and a glass container coated with silicone rubber by the processing method. The processing method comprises: cleaning a glass container body and performing a first drying treatment; brushing or spraying a primer on a surface of a part of the glass container body, wherein the surface of the part of the glass container body is to be coated with silicone rubber; performing a second drying treatment on the glass container body, and then cooling the glass container body to a room temperature; putting the glass container body into a mold cavity of a mold, injecting the liquid silicone rubber into the mold cavity, and vulcanizing the liquid silicone rubber for 200 to 300 seconds; opening the mold and letting the mold sliding out, and taking out the glass container coated with the silicone rubber layer.

### CROSS-REFERENCE TO RELATED APPLICATION

This application claims the priority benefit of China application serial no. 202011391548.5, filed on Dec. 2, 2020. The entirety of the above-mentioned patent application is hereby incorporated by reference herein and made a part of this specification.

### BACKGROUND

### Technical Field

The present invention relates to the technical field of container processing, in particular to a processing method for coating glass container with silicone rubber and a glass container coated with silicone rubber.

### Description of Related Art

Existing glass containers with container bodies coated with silicone rubber, such as silicone-rubber coated glass cup, bottles, bowls, plates, trays, etc., are usually used for holding food, water or beverages. A separate silicone rubber is sheathed on or stuck to the container body of the glass container and the silicone rubber part can be completely separable, or a relative thin layer of silicone rubber is sprayed on the body of the glass container by spraying, which cannot truly reflect the advantages of the product combined by the silicone rubber and the glass container body and even bring some bad experience, such as separate cleaning and increased cleaning burden, to the user due to the two separate parts. Since the two are separated and cannot be closely engaged, and there is a gap between the two materials, which is easy to trap dirt and the like. For example, Chinese utility model patent publication No. CN204743555U with publication date of 2015 Nov. 11, discloses a cup with a silicone rubber cover, wherein the silicone rubber cover is detachably mounted on the cup body. Since the silicone rubber cover is separable with the cup, the cup with the silicone rubber cover has the above-mentioned defects such as inconvenient cleaning and so on. Therefore, there is an urgent need to make improvements in the processing technology of glass containers to solve the defects of existing products.

### SUMMARY

To overcome at least one of the defects in the above prior art, the present invention provides a processing method for coating glass container with silicone rubber and a glass container coated with silicone rubber processed by the processing method.

In order to solve the above technical problems, the present invention adopts the following technical solution:

A processing method for coating glass container with silicone rubber, wherein the processing method comprises the following steps:

step (1): cleaning a glass container body and performing a first drying treatment;

step (2): brushing or spraying a primer on a surface of a part of the glass container body, wherein the surface of the part of the glass container body is to be coated with silicone rubber;

step (3): performing a second drying treatment on the glass container body, and then cooling the glass container body to a room temperature;

step (4): putting the glass container body into an upper mold of a mold, closing front and rear middle plates such that the glass container body is wrapped, moving a top plate of the upper mold downward and a gun barrel of an injection machine bearing against the top plate of the upper mold, injecting a liquid silicone rubber into a mold cavity formed by the upper mold abutted against a lower mold and vulcanizing the liquid silicone rubber for 200 to 300 seconds, such that the surface of the part of the glass container body to be coated with silicone rubber is coated with a silicone rubber layer;

step (5): opening the mold and letting the mold sliding out, and taking out the glass container coated with the silicone rubber layer.

Using above technical solution, the glass container body and the silicone rubber layer may be integrally formed, such that the silicone rubber layer may be firmly attached to the surface of the glass container body without falling off. Since the silicone rubber layer will not be separated from the glass container body, the cleaning burden that the two are cleaned separately is reduced. The glass container body and the silicone rubber layer processed using the technical solution can be closely attached to each other, and there will be no gap between the two to trap dirt, which facilitates cleaning. In addition, using this technical solution, the amount of injected silicone rubber can be controlled according to needs, such that glass containers with silicone rubber layers of different thicknesses, different colors and patterns can be processed according to needs, which can meet the customized needs of consumers or purchasers.

Preferably, a flexible protective cover made of heat-resistant material is sheathed on a mold core of the mold before step (4). The flexible protective cover prevents the glass container body from directly contacting the mold core. When the glass container body is squeezed by the silicone rubber injected into the mold cavity or is squeezed due to the expanding of the heated mold core, the flexible protective cover provides buffering to the glass container body to prevent the glass container body from being squeezed and damaged. At the same time, the flexible protective cover can be deformed under pressure, so it can compensate for the error defect of the glass size and improve the qualified rate of the finished product. In addition, since the flexible protective cover is made of heat-resistant material, it can prevent the flexible protective cover from being melted when heated during the processing of the glass container.

Preferably, the flexible protective cover is made of silicone rubber. The flexible protective cover made of heat-resistant silicone, i.e., the silicone cover, has very good heat resistance, is not easy to be melted in a high temperature environment and can maintain good resilience. It is very suitable for providing buffer protection during the processing of the glass container body.

Preferably, a material of the liquid silicone rubber in step (4) is A, B mixed liquid silicone rubber. The liquid silicone rubber formed by A, B mixed liquid silicone rubber has characteristics such as excellent high transparency, good flow properties, fast forming speed, anti-yellowing, heat aging resistance, excellent tear strength, safety and environmental protection, and can fully meet food-grade requirements. And such liquid silicone rubber may be molded by injection molding with low energy consumption, which improves processing efficiency.

Preferably, in step (1), the first drying treatment is natural air drying, and in step (3), the second drying treatment is baking the glass container body at a temperature of 50 to 200 degrees Celsius for 5 to 60 minutes. More preferably, in step (1), the drying treatment is natural air drying for 20 to 35 minutes, and in step (3), the second drying treatment is putting the glass container body in an oven and baking at a temperature of 80 to 150 degrees Celsius for 10 to 30 minutes.

Preferably, in step (2), a brush or a spray gun is used to brush or spray the primer on the surface of the part of the glass container body to be coated with silicone rubber.

Preferably, in step (4), a time for vulcanizing the liquid silicone rubber is 220 to 280 seconds. The molding temperature of the silicone rubber layer of the glass container is 80 to 180 degrees Celsius. More preferably, in step (4), the time for vulcanizing the liquid silicone rubber is 230 to 270 seconds. The molding temperature of the silicone rubber layer of the glass container is 100 to 150 degrees Celsius.

The present invention also provides the following technical solutions.

A glass container coated with silicone rubber processed by the above processing method, wherein a part or a designated position of the glass container body is coated with the silicone rubber layer, and the glass container body and the silicone rubber layer are integrally formed.

With regard to the glass container of this solution, the glass container body and the silicone rubber layer are integrally formed using the aforementioned processing method, such that the silicone rubber layer may be firmly attached to the surface of the glass container body without falling off. Since the silicone rubber layer will not be separated from the glass container body, the cleaning burden that the two are cleaned separately is reduced. The glass container body and the silicone rubber layer processed using the technical solution can be closely attached to each other, and there will be no gap between the two to trap dirt, which facilitates cleaning.

Preferably, the glass container is a glass cup, and the cup body of the glass cup is provided with an annular step that defines a first part of the cup body of the glass cup close to a rim of the glass cup and a second part far away from the rim of the glass cup. A surface of the second part is coated with the silicone rubber layer. Since the second part is coated with a silicone rubber layer, the second part has functions of scalding prevention and heat insulation, and is convenient to be held by users. The first part of the cup body of the glass cup close to the rim of the glass cup is preferably not coated with the silicone rubber layer, such that the user can directly see the glass material of the glass cup and keep the glass transparent. The silicone rubber layer below the annular step can present diversified colors, which increases selectivity. And the mouth of the user can directly touch the glass of the rim of the glass cup when drinking, which has a good sense of touch and is more environmentally friendly. At the same time, such design can overcome the defect of fouling which caused by complete coating of the silicone rubber layer on the entire outer wall of the cup body. The design is more hygienic and reduces the difficulty of cleaning. More preferably, the silicone rubber of the second part may fits with the annular step to beautify the appearance.

Preferably, the glass container is a glass bottle, and a convex ring near an opening of the glass bottle is provided on a bottle body of the glass bottle. A surface of a part of the bottle body located at the lower side of the convex ring is coated with the silicone rubber layer. Since the surface of the part of the bottle body located on the lower side of the convex ring is coated with a silicone rubber layer, it can prevent scalding and heat insulation and is convenient to be held by users. The surface of the convex ring is preferably not coated with a silicone rubber layer, such that the user can directly see part of the glass of the glass bottle through the convex ring made of glass material, keeping the glass transparent. The silicone rubber layer below the convex ring can present diversified colors, which increases the selectivity. And the mouth of the user can directly touch the glass at the opening of the glass bottle when drinking, which has a good sense of touch and is more environmentally friendly. At the same time, such design can overcome the defect of fouling which caused by complete coating of the silicone rubber layer on the entire outer wall of the bottle body. The design is more hygienic and reduces the difficulty of cleaning.

More preferably, the thickness of the silicone rubber layer is consistent with the height of the convex ring such that the silicone rubber layer can be flush with the convex ring to beautify the appearance.

Preferably, a non-slip structure is formed on a surface of the silicone rubber layer. The non-slip structure helps to increase the friction when the user holds the glass cup, effectively prevent slipping, and improves the user's experience. The non-slip structure is preferably non-slip ridges. The non-slip ridges not only have an effect for prevent slipping, but also form a pattern that can beautify the appearance of the glass cup and bring good visual enjoyment to users.

Preferably, the diameter of the transverse cross-section of the glass cup from the rim to the bottom gradually decreases. The whole glass cup has a shape that the rim has a large diameter and the bottom has a small diameter, such that multiple glass cups can be stacked on top of each other, which effectively saves storage space and is suitable for more convenient transportation.

Compared with the prior art, the present invention has the following beneficial effects:

With the technical solution, the glass container body and the silicone rubber layer may be integrally formed, such that the silicone rubber layer may be firmly attached to the surface of the glass container body without falling off. Since the silicone rubber layer will not be separated from the glass container body, the cleaning burden that the two are cleaned separately is reduced. The glass container body and the silicone rubber layer processed using the technical solution can be closely attached to each other, and there will be no gap between the two to trap dirt, which facilitates cleaning. In addition, using this technical solution, it is possible to process glass containers coated with silicone in specific positions, with different thicknesses, different colors, and different patterns, which can meet the customization needs of consumers or purchasers. The glass container of the present invention has the functions to prevent slipping, scalding, and to resist crash. The glass container of the present invention is convenient for carrying and has beautiful appearance, which realizes an environmentally friendly product that combines glass and silicone rubber perfectly.

### BRIEF DESCRIPTION OF THE DRAWINGS

FIG. 1 is a schematic structural view of a glass cup in embodiment 7 of the present invention.

FIG. 2 is schematic structural view of the glass cup in embodiment 7 of the present invention shown from another angle.

FIG. 3 is a cross-sectional view at A-A in FIG. 2.

FIG. 4 is an exploded schematic structural view of the glass cup in embodiment 7 of the present invention.

FIG. 5 is an exploded schematic structural view of the glass cup in embodiment 7 of the present invention shown from another angle.

FIG. 6 is a schematic structural view of a cup body of the glass cup in embodiment 7 of the present invention.

FIG. 7 is an enlarged schematic structural view of position B in FIG. 6.

FIG. 8 is a schematic structural view of a glass bottle in embodiment 8 of the present invention.

FIG. 9 is an exploded schematic structural view of the glass bottle in embodiment 8 of the present invention.

### DESCRIPTION OF THE EMBODIMENTS

The accompanying drawings are only for exemplary description, and shall not be construed as limiting the present invention. For ease of description, some parts in the accompanying drawings may be omitted, scaled up or scaled down, which do not represent the practical dimensions of the product. For a person skilled in the art, it is understandable that some commonly known structures may be omitted in accompanying drawings and that their descriptions may be omitted. The positional relationship described in the accompanying drawings is for illustrative purposes only, and shall not be understood as limiting to the present invention.

### Embodiment 1

A processing method for coating glass container with silicone rubber in the present embodiment comprises the following steps:

step (1): cleaning a glass container body with a cleaning agent and performing a first drying treatment;

step (2): brushing or spraying a primer on a surface of a part of the glass container body, wherein the surface of the part of the glass container body is to be coated with silicone rubber;

step (3): drying the glass container body, and then cooling the glass container body to a room temperature;

step (4): putting the glass container body into a mold cavity of a mold, closing front and rear middle plates, moving a lower mold under a upper mold seat, closing the mold, using pressure to pass the liquid silicone rubber through a feeder to an injection machine, and passing through a gun barrel into the mold cavity, and vulcanizing the liquid silicone rubber for 200 to 300 seconds, such that the surface of the part of the glass container body to be coated with silicone rubber is coated with a silicone rubber layer;

step (5): opening the mold and letting the mold sliding out, and taking out the glass container coated with the silicone rubber layer.

During actual production or processing of the glass container body, the glass container body may be contaminated with dust or oil. Therefore, it's necessary for the glass container body to be cleaned in step (1). In the present embodiment, household cleaning agents can be used to clean the glass container body, such that the injected silicone rubber can completely attached to the glass surface. Of course, in other embodiments, other manners can be used for cleaning as needed, for example, other cleaning agents are used for cleaning.

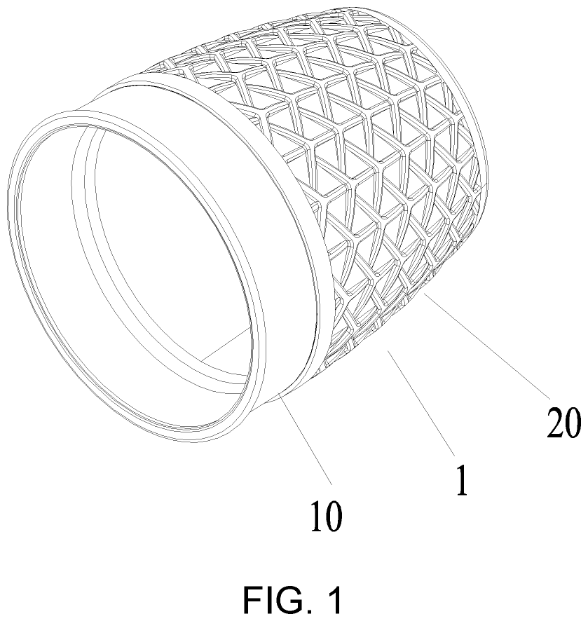

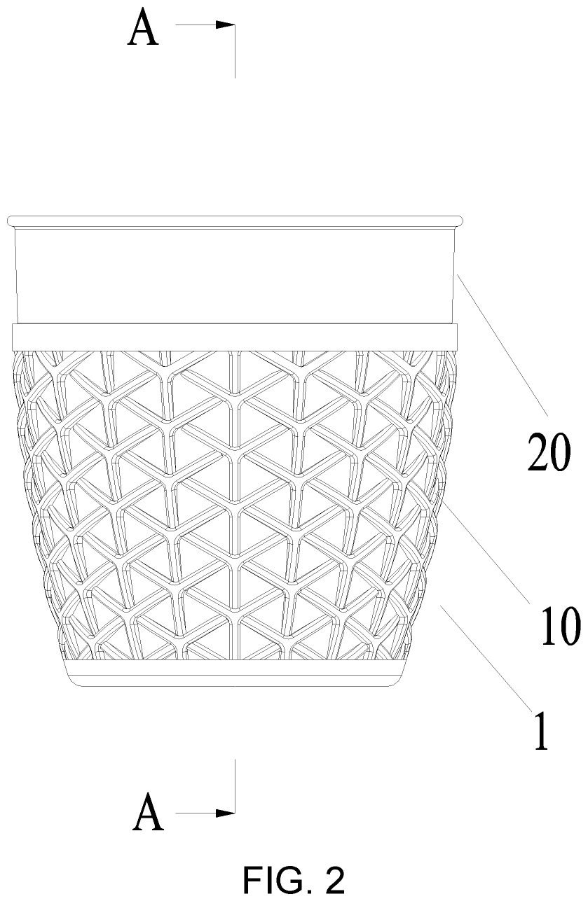

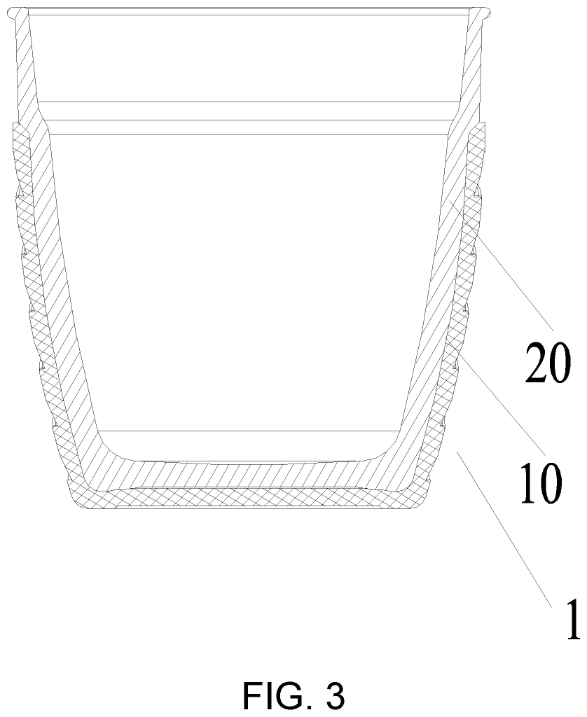

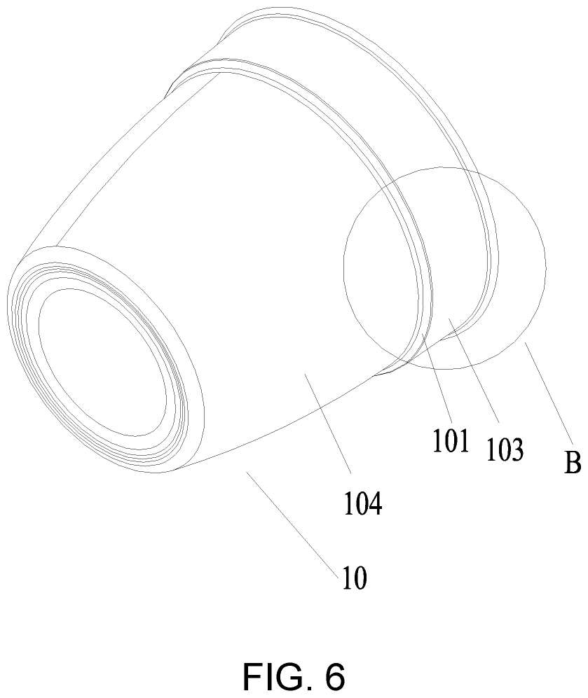

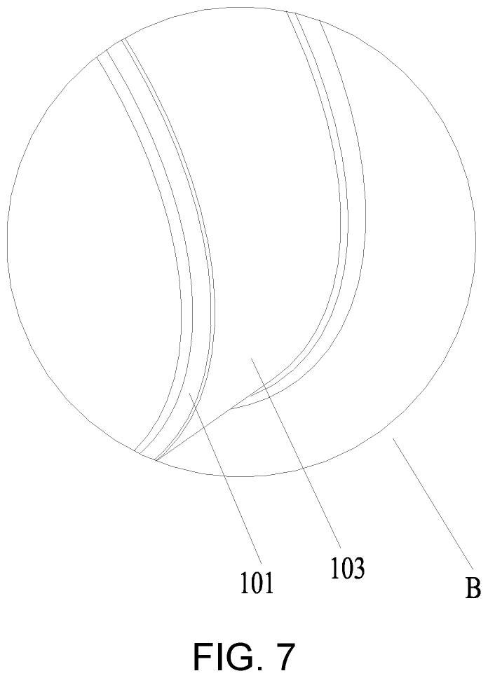

Reference to FIGS. 1-7, in this embodiment, the glass container is a glass cup 1, and the glass container body is the cup body 10 of the glass cup 1. The primer used in step (2) is Chongxin CX-609-13#, which can be brushed or sprayed on the surface of the glass container body to be coated with silicone rubber using a brush or spray gun. In the present embodiment, it is brushed or sprayed on the surface of the second part 104 of the cup body 10. In the present embodiment, the first drying treatment in step (1) is natural air drying. It is understood that in other embodiments, the first drying treatment can also be performed in other manners, such as placing the cup body 10 in an oven for drying.

In the present embodiment, step (1) specifically is to clean the cup body 10 of the glass cup 1 with household cleaning agents and let it air dry naturally for 5 minutes. Step (2) specifically is to use a brush to brush the primer of Chongxin CX-609-13# on the surface of the second part 104 of the cup body 10, and to bake the cup body 10 in an oven at a temperature of 50 degrees Celsius for 60 minutes. Then take it out, let it cool naturally to room temperature, and set it aside for use. In step (4), specifically, invert the cup body 10 of the glass cup brushed with the primer on a lower mold of a mold, activate a switch, close front and rear middle plates to wrap the cup body 10, move the lower mold under an upper mold seat, close the mold, use pressure to pass the liquid silicone rubber through a feeder to an injection machine, inject the liquid silicone rubber into the mold cavity through a gun barrel and vulcanize the liquid silicone rubber for 200 seconds. In step (5), open the mold, let the mold out sliding out, separate the middle plates, and take out the glass cup 1 coated with silicone rubber layer 20. Then the processing and forming of a product is completed. If the processing of other products needs to be continued, just proceed to the next cycle operation.

In the present embodiment, before the glass container body is put into the mold cavity of the mold, a silicone rubber cover is sheathed on a mold core of the mold. The processing equipment used in the present embodiment a vertical liquid silicone rubber injection molding machine. A material of the liquid silicone rubber is A, B mixed liquid silicone rubber. The cup body 10 of the glass cup is made of soda-lime glass. The molding temperature of the silicone rubber layer of the glass container is 80 degrees Celsius.

The processing equipment in the present embodiment, namely the vertical liquid silicone rubber injection molding machine, uses the following process parameters:

The clamping high pressure is 30-100 BAR, and the running speed is 10˜30%;

the set temperature of the upper mold is 100˜200 degrees Celsius, and the temperature of the upper mold is 100˜200 degrees Celsius;

the storage position is 30˜80 mm, the pressure is 30˜100 BAR, and the operating speed is 45%.

The injection pressure is divided into three sections:

The position of the first section is 25˜35 mm, the injection pressure is 10˜20 BAR, and the injection speed is 8˜20%;

the position of the second section is 20˜30 mm, the injection pressure is 8˜15 BAR, and the injection speed is 5˜15%;

the position of the third section is 15˜25 mm, the injection pressure is 5˜10 BAR, and the injection speed is 2˜8%.

The parameter values of the position of the first section are greater than those of the position of the second section, and the parameter values of the position of the second section are greater than those of the position of the third section.

### Embodiment 2

The difference between the present embodiment and embodiment 1 lies only in the followings:

In step (1), the cup body 10 of the glass cup 1 is cleaned with household cleaning agents and air dried naturally for 60 minutes. In step (2), spray guns are used to spray the primer of Chongxin CX-609-13# on the surface of the second part 104 of the cup body 10 of the glass cup 1. The second drying treatment in step (3) is to put the glass container body in an oven and bake it at a temperature of 200 degrees Celsius for 5 minutes. In step (4), the time for vulcanizing the liquid silicone rubber is 300 seconds. The molding temperature of the silicone rubber layer of the glass container is 180 degrees Celsius.

### Embodiment 3

The difference between the present embodiment and embodiment 1 lies only in the followings:

In step (1), the cup body 10 of the glass cup 1 is cleaned with household cleaning agents and air dried naturally for 30 minutes. The second drying treatment in step (3) is to put the glass container body in an oven and bake it at a temperature of 120 degrees Celsius for 12 minutes. In step (4), the time for vulcanizing the liquid silicone rubber is 220 seconds. The molding temperature of the silicone rubber layer of the glass container is 100 degrees Celsius.

### Embodiment 4

The difference between the present embodiment and embodiment 1 lies only in the followings:

In step (4), the time for vulcanizing the liquid silicone rubber is 230 seconds.

### Embodiment 5

The difference between the present embodiment and embodiment 1 lies only in the followings:

In step (4), the time for vulcanizing the liquid silicone rubber is 270 seconds. The molding temperature of the silicone rubber layer of the glass container is 150 degrees Celsius.

### Embodiment 6

The difference between the present embodiment and embodiment 1 lies only in the followings:

In step (4), the time for vulcanizing the liquid silicone rubber is 240 seconds. The molding temperature of the silicone rubber layer of the glass container is 120 degrees Celsius.

### Embodiment 7

As shown in FIGS. 1-3, a glass cup 1 coated with silicone rubber processed by the processing method in the above embodiments, wherein a part of the cup body 10 of the glass cup 1 is coated with a silicone rubber layer 20, and the cup body 10 and the silicone rubber layer 20 are integrally formed. Since the cup body 10 and the silicone rubber layer 20 are integrally formed, the silicone rubber 20 may be firmly attached to the surface of the cup body 10 without falling off. Since the silicone rubber layer 20 will not be separated from the cup body 10, the cleaning burden that the two are cleaned separately is reduced. The cup body 10 and the silicone rubber layer 20 in the present embodiment can be closely attached to each other, and there will be no gap between the two to trap dirt, which facilitates cleaning.

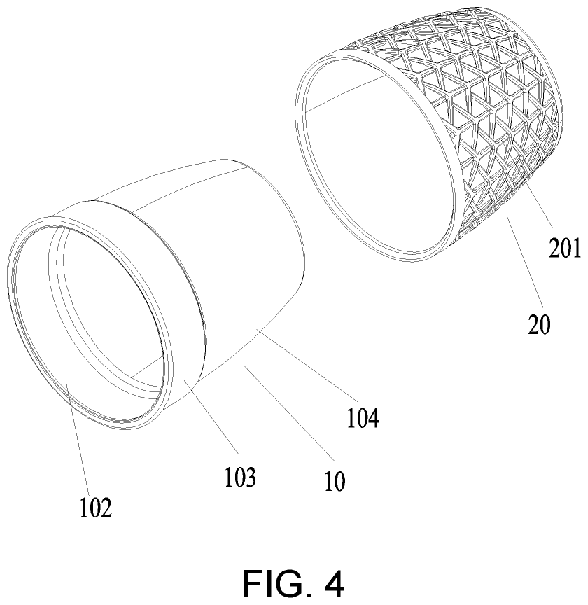

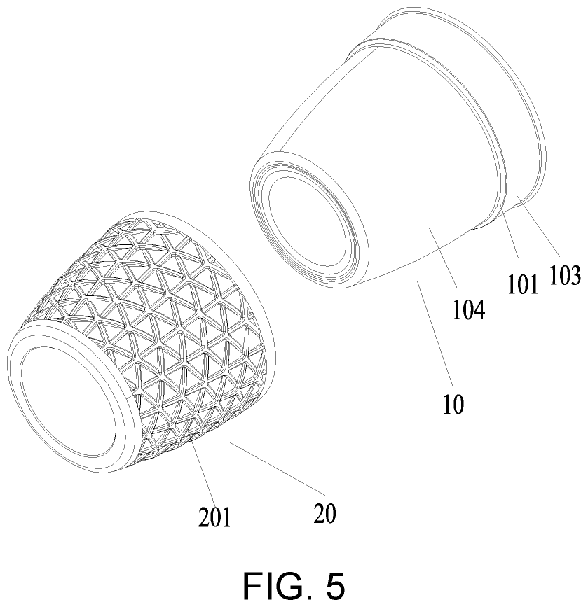

As shown in FIGS. 4-7 (in order to clearly show the structure of the glass cup 1, FIGS. 4 and 5 show the exploded structure of the glass cup 1. It should be understood that the cup body 10 and the silicone rubber layer 20 of the glass cup 1 in the present embodiment are actually tightly fitted with each other and inseparable), the cup body 10 of the glass cup 1 is provided with an annular step 101 that defines a first part 103 of the cup body 10 of the glass cup 1 close to a rim 102 of the glass cup 1 and a second part 104 far from the rim 102 of the glass cup 1. A surface of the second part 104 is coated with the silicone rubber layer 20. Since the second part 104 is coated with a silicone rubber layer 20, the second part has functions of scalding prevention and heat insulation, and is convenient to be held by users. The first part 103 of the cup body 10 close to the rim 102 of the glass cup 1 is not coated with the silicone rubber layer 20, such that the user can directly see the glass material of the cup body 10, which increases the ornamental value. And the mouth of the user can directly touch the glass at the rim 102 of the glass cup 1 when drinking, which has a good sense of touch and is more environmentally friendly. The upper edge of the silicone rubber layer 20 of the second part 104 fits with the annular step 101 to beautify the overall appearance of the glass cup 1. Non-slip ridges 201 are formed on the surface of the silicone rubber layer 20 coated on the second part 104. The non-slip ridges 201 help to increase the friction when the user holds the glass cup 1, effectively prevent slipping, and improves the user's experience. A pattern formed by the non-slip ridges 201 can beautify the appearance of the glass cup 1, realize the perfect combination of glass and silicone rubber, and bring good visual enjoyment to users.

### Embodiment 8

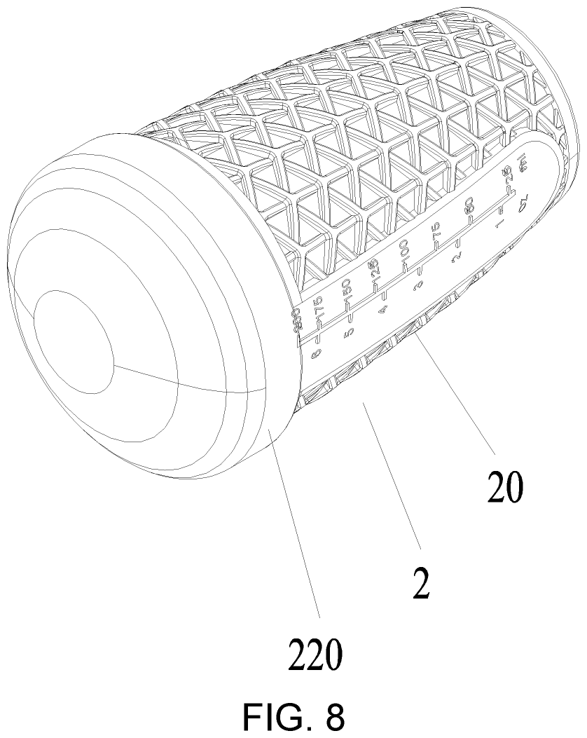

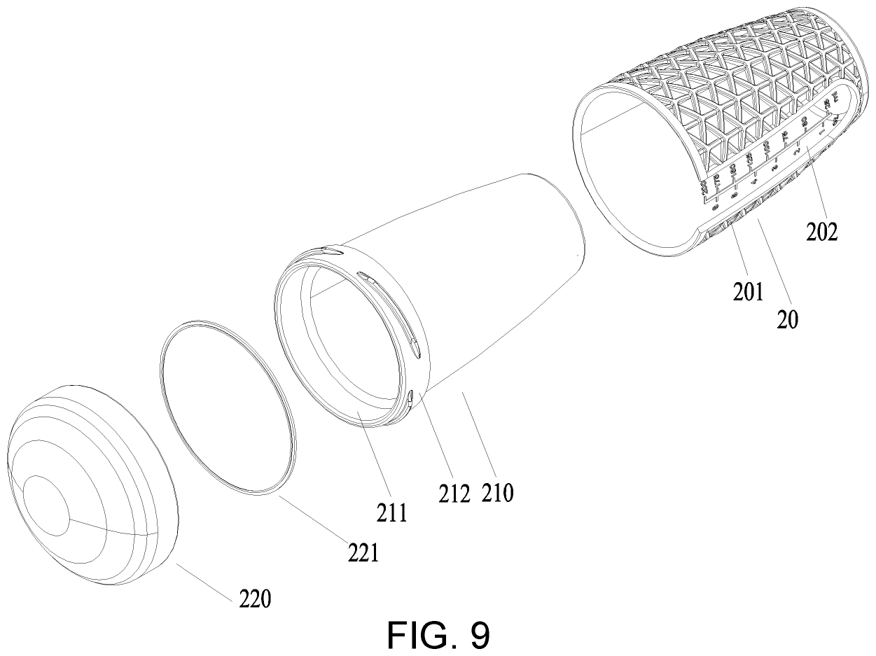

As shown in FIGS. 8-9, a glass bottle 2 coated with silicone rubber processed by the processing method in the above embodiments, wherein a part of the bottle body 210 is coated with a silicone rubber layer 20 of the glass bottle 2. Since the bottle body 210 and the silicone rubber layer 20 are integrally formed, the silicone rubber 20 may be firmly attached to the surface of the bottle body 210 without falling off. Since the silicone rubber layer 20 will not be separated from the bottle body 210, the cleaning burden that the two are cleaned separately is reduced. The bottle body 210 and the silicone rubber layer 20 in the present embodiment can be closely attached to each other, and there will be no gap between the two to trap dirt, which facilitates cleaning. A convex ring 212 near an opening 211 of the glass bottle 2 is provided on the bottle body 210 of the glass bottle 2, and a surface of a part of the bottle body 210 located at the lower side of the convex ring 212 is coated with the silicone rubber layer 20.

Since the surface of the part of the bottle body 210 located at the lower side of the convex ring 212 is coated with a silicone rubber layer 20, it has scalding prevention and heat insulation and is convenient to be held by users. The surface of the convex ring 212 in the present embodiment is not coated with a silicone rubber layer, so that the user can directly see part of the glass of the glass bottle through the convex ring 212 made of glass material, keeping transparency of the glass. The silicone rubber layer below the convex ring 212 can present diversified colors, which increases the selectivity. And the mouth of the user can directly touch the glass at the opening 211 of the glass bottle 2 when drinking, which has a good sense of touch and is more environmentally friendly. At the same time, such design can overcome the defect of fouling which caused by complete coating of the silicone rubber layer 20 on the entire outer wall of the bottle body 210. The design is more hygienic and reduces the difficulty of cleaning. The thickness of the silicone rubber layer 20 is substantially consistent with the height of the convex ring 212 such that the silicone rubber layer 20 can be flush with the convex ring 212 to beautify the appearance.

Non-slip ridges 201 are formed on the surface of the silicone rubber layer 20. The non-slip ridges 201 help to increase the friction when the user holds the glass bottle 2, and help to effectively prevent slipping, and improve the user's experience. A pattern formed by the non-slip ridges 201 can beautify the appearance of the glass bottle 2, and bring good visual enjoyment to users.

The surface of the silicone rubber layer 20 is further provided with a scale 202 to facilitate the user measuring the liquid contained in the glass bottle 2.

The glass bottle 2 further includes a cap 220 that fits with the opening 211. The inner side of the cap 220 is further provided with a sealing member 221, and the sealing member 221 is a silicone rubber gasket. In the present embodiment, the inner side of the cap is provided with threads, the convex ring 212 is provided with male threads, and the cap 220 can be threadedly connected with the convex ring 212. When in use, the cap 220 is placed at the opening 211 to connect with the convex ring 212, and it can be tightly closed by rotating and tightening.

The above-mentioned embodiments are merely preferred embodiments the present invention, but the design concept of the present invention is not limited to these embodiments. Any insubstantial modification made to the present invention using this concept should be included in the protection scope of the present invention.

what is claimed is:

1. A processing method for coating glass container with silicone rubber, comprising the following steps:
step 1: cleaning a glass container body and performing a first drying treatment;
step 2: brushing or spraying a primer on a surface of a part of the glass container body, wherein the surface of the part of the glass container body is to be coated with silicone rubber;
step 3: performing a second drying treatment on the glass container body, and then cooling the glass container body to a room temperature;
step 4: putting the glass container body into a mold cavity of a mold, closing front and rear middle plates, moving a lower mold under a upper mold seat, closing the mold, using pressure to pass the liquid silicone rubber through a feeder to an injection machine, and passing through a gun barrel into the mold cavity, and vulcanizing the liquid silicone rubber for 200 to 300 seconds, such that the surface of the part of the glass container body to be coated with silicone rubber is coated with a silicone rubber layer; and
step 5: opening the mold and letting the mold sliding out, and taking out the glass container coated with the silicone rubber layer.

2. The processing method according to claim 1, wherein a flexible protective cover made of heat-resistant material is sheathed on a mold core of the mold before the step 4.

3. The processing method according to claim 1, wherein a material of the liquid silicone rubber in the step 4 is A, B mixed liquid silicone rubber.

4. The processing method according to claim 1, wherein in the step 1, the first drying treatment is natural air drying, and in the step 3, the second drying treatment is baking the glass container body at a temperature of 50 to 200 degrees Celsius for 5 to 60 minutes.

5. The processing method according to claim 1, wherein in the step 2, a brush or a spray gun is used to brush or spray the primer on the surface of the part of the glass container body to be coated with silicone rubber.

6. The processing method according to claim 1, wherein in the step 4, a time for vulcanizing the liquid silicone rubber is 220 to 280 seconds.

7. A glass container coated with silicone rubber processed by the processing method according to claim 1, wherein a part or a designated position of the glass container body is coated with the silicone rubber layer (20), and the glass container body and the silicone rubber layer (20) are integrally formed.

8. The glass container coated with silicone rubber according to claim 7, wherein the glass container is a glass cup (1), a cup body (10) of the glass cup (1) being provided with an annular step (101) that defines a first part (103) of the cup body (10) of the glass cup (1) close to a rim (102) of the glass cup (1) and a second part (104) far from the rim (102) of the glass cup (1), a surface of the second part (104) being coated with the silicone rubber layer (20).

9. The glass container coated with silicone rubber according to claim 7, wherein the glass container is a glass bottle (2), a convex ring (212) near an opening (211) of the glass bottle (2) being provided on a bottle body (210) of the glass bottle (2), and a surface of a part of the bottle body (210) located at the lower side of the convex ring (212) being coated with the silicone rubber layer (20).

10. The glass container coated with silicone rubber according to claim 8, wherein a non-slip structure is formed on a surface of the silicone rubber layer (20).

11. The glass container coated with silicone rubber according to claim 9, wherein a non-slip structure is formed on a surface of the silicone rubber layer (20).

12. A glass container coated with silicone rubber processed by the processing method according to claim 2, wherein a part or a designated position of the glass container body is coated with the silicone rubber layer (20), and the glass container body and the silicone rubber layer (20) are integrally formed.

13. A glass container coated with silicone rubber processed by the processing method according to claim 3, wherein a part or a designated position of the glass container body is coated with the silicone rubber layer (20), and the glass container body and the silicone rubber layer (20) are integrally formed.

14. A glass container coated with silicone rubber processed by the processing method according to claim 4, wherein a part or a designated position of the glass container body is coated with the silicone rubber layer (20), and the glass container body and the silicone rubber layer (20) are integrally formed.

15. A glass container coated with silicone rubber processed by the processing method according to claim 5, wherein a part or a designated position of the glass container body is coated with the silicone rubber layer (20), and the glass container body and the silicone rubber layer (20) are integrally formed.

16. A glass container coated with silicone rubber processed by the processing method according to claim 6, wherein a part or a designated position of the glass container body is coated with the silicone rubber layer (20), and the glass container body and the silicone rubber layer (20) are integrally formed.
